(19) United States
(12) Patent Application Publication
(10) Pub. No.: US 2015/0103377 A1
(43) Pub. Date: Apr. 16, 2015

(54) PRINTING SYSTEM, PRINTING APPARATUS, MOBILE DEVICE AND METHOD OF PRINTING FROM A MOBILE DEVICE

(71) Applicant: CANON EUROPA N.V., Amstelveen (NE)

(72) Inventors: Benjamin John Parks, Reading (GB); Pierre-Jean Champault, Chiswick (GB); Jiawei Hu, Reading (GB)

(21) Appl. No.: 14/513,704

(22) Filed: Oct. 14, 2014

(30) Foreign Application Priority Data
Oct. 14, 2013 (GB) 1318136.7

(51) Int. Cl. H04N 1/00; G06F 3/12; H04W 4/16; H04L 12/58

(52) U.S. Cl. CPC H04N 1/00307; H04L 51/04; G06F 3/1268; G06F 3/1292; H04W 4/16; H04N 2201/0094
USPC 358/1.15

(57) ABSTRACT

A method of printing an email comprising the steps of sending an email to be printed to an email address associated with a printing apparatus using an email application on a mobile device and receiving identifying information at the email application in response to the sent email. Identifying information is passed from the email application to a printing application. The printing application sends an instruction to print an email to the printing apparatus. The printing apparatus retrieves the email for printing from the email address associated with the printing apparatus and prints the email.

### CROSS-REFERENCE TO RELATED APPLICATIONS

This application claims the benefit of United Kingdom Patent Application No. 1318136.7, filed Oct. 14, 2013, which is hereby incorporated by reference herein in its entirety.

### BACKGROUND OF THE INVENTION

1. Field of the Invention

The present invention relates to a printing system, printing apparatus, a mobile device, a method of printing an email, a printer-side application and a printing application.

2. Description of the Related Art

It is known to print from a mobile device, such as a mobile phone, to a printing apparatus, such as an MFP (multifunctional peripheral). According to one known system an application is installed on the mobile phone, for example by downloading the application from iTunes® or the Google® Play store for iOS and Android® devices respectively. Further a second application is installed on the MFP. A connection is configured between the mobile phone and the MFP over a Wi-Fi network by configuring the IP address of the MFP at the mobile phone. Images may then be transferred between the mobile phone and the MFP using HTTP over the configured Wi-Fi connection. The images are then printed by the MFP.

However, there is a drawback with the current systems when it comes to printing emails. Email on mobile phones, such as iOS and Android®, is typically provided through a standalone application. Neither the email application nor the operating system typically allows other applications to access received email body content, so that it is difficult or impossible to access the emails from the printing application to allow printing of the email. Access to such emails for printing is in contrast to other files, such as images, which may be accessed by the printing application using a suitable method depending upon the operating system.

An aim of the present invention is to provide a method of printing the body content of emails from a mobile device using a printing application installed on the mobile device.

### SUMMARY OF THE INVENTION

According to a first aspect of the present invention there is provided a printing system comprising a mobile device and a printing apparatus, the mobile device comprising: a printing application and an email application, wherein the email application is operable to forward an email for printing to an email address associated with a printing apparatus, and the printing application is operable to send an instruction to print an email to the printing apparatus; and the printing apparatus comprising an printer-side application operable, in response to the instruction, to retrieve an email for printing from the email address associated with the printing apparatus and to cause printing of the retrieved email.

By sending the email to the email address associated with the printing apparatus from the mobile device and the printer-side application retrieving an email for printing from the email address, a problem that the printing application cannot directly access emails stored by the email application may be overcome.

In some embodiments the email application is operable to receive identifying information in response to the sent email, and to pass the identifying information from the email application to the printing application on the mobile device. In such embodiments the printing application may be operable to send a request to the printer-side application including the identifying information and to receive and display a list of emails that may be printed. The printer-side application may be configured to receive the request including the identifying information and to search for emails received at the email address associated with the printing apparatus in order to generate a list of emails that may be printed, and to send the list of emails that may be printed to the printing application at the mobile device. In this way, a user may use identifying information received in connection with one email for printing to view and select from all of the emails that the user has sent to the printing apparatus for printing. In some such embodiments the printing application is configured to send to the printing apparatus an instruction to print an email selected by a user from the list of emails. The printer-side application may be configured to identify an email address associated with the identifying information and to form a list of emails that have been sent from the email address.

In some embodiments the printer-side application is configured to generate the identifying information that identifies a received email upon receipt of the email for printing from the email application. In such embodiments the identifying information may be unique identifying information generated based on details of the received email for printing. More particularly, the identifying information may be generated using the sender's email address and a time stamp.

In some embodiments the printer-side application is configured to, in a case where the retrieved email is in an unsupported format, cause the email content to be rendered at the mobile device prior to printing by the printing apparatus. In such embodiments the printer-side application may be configured to generate a resource by replacing references in email code of the retrieved email, wherein the printing application on the mobile device may be configured to obtain the resource and cause the resource to be rendered. The printing application may be configured to cause the resource to be rendered by passing the resource to browser software on the mobile device.

In other embodiments where the printer-side application is configured to, in a case where the retrieved email is in an unsupported format, cause the email content to be rendered at the mobile device prior to printing by the printing apparatus, the printer-side application may be configured to generate a resource by injecting images referred to in the email code of the retrieved email into the email code and wherein the printing application on the mobile device is configured to cause the resource to be rendered.

According to a second aspect of the present invention there is provided a method of printing an email comprising the steps of: sending an email to be printed to an email address associated with a printing apparatus using an email application on a mobile device; using a printing application to send an instruction to print an email to the printing apparatus; and the printing apparatus, in response to the instruction, retrieving the email for printing from the email address associated with the printing apparatus and printing the retrieved email.

According to a third aspect of the present invention there is provided a mobile device comprising a printing application and an email application, wherein the email application is operable to forward an email for printing to an email address associated with a printing apparatus, to receive identifying information at the email application in response to the sent email, and to pass the identifying information from the email application to the printing application, and the printing application is operable to send an instruction to print an email to the printing apparatus.

According to a fourth aspect of the present invention there is provided a method of a mobile device comprising a printing application and an email application, the method comprising the email application forwarding an email for printing to an email address associated with a printing apparatus, receiving identifying information at the email application in response to the sent email, and passing the identifying information from the email application to the printing application, and the printing application sending an instruction to print an email to the printing apparatus.

According to a fifth aspect of the present invention there is provided a printing apparatus comprising a printer-side application configured to generate the identifying information that identifies a received email upon receipt of an email for printing sent to an email address associated with the printing apparatus from an email application of a mobile device, and operable to retrieve an email for printing from the email address associated with the printing apparatus and to cause printing of the retrieved email upon receipt of an instruction to print the email.

According to a sixth aspect of the present invention there is provided a method of a printing apparatus comprising: a printer-side application, the method comprising generating identifying information that identifies a received email upon receipt of an email for printing sent to an email address associated with the printing apparatus from an email application of a mobile device; retrieving an email for printing from the email address associated with the printing apparatus; and causing printing of the retrieved email upon receipt of an instruction to print the email.

A seventh aspect of the present invention provides a printer-side application configured to generate identifying information that identifies a received email upon receipt of an email for printing sent to an email address associated with the printing apparatus from an email application of a mobile device, and operable to retrieve an email for printing from the email address associated with the printing apparatus and to cause printing of the retrieved email upon receipt of an instruction to print the email.

An eighth aspect of the present invention provides a printing application operable to receive identifying information from an email application; to send a request to a printer-side application on an printing apparatus, including the identifying information, to receive a list of emails that may be printed from the printer-side application; to display a list of emails that may be printed; and to send an instruction to print an email to the printing apparatus.

### BRIEF DESCRIPTION OF THE DRAWINGS

Embodiments of the present invention will now be described, by way of example only, with reference to the accompanying figures in which:

FIG. 1 shows architecture of the first embodiment;

FIG. 2 shows hardware configuration of an MFP;

FIG. 3 shows hardware configuration of a mobile phone;

FIG. 4 shows hardware configuration of an email server;

FIG. 5 shows a software architecture of the MFP;

FIG. 6 shows the software architecture of the mobile phone;

FIG. 7 is a flowchart showing steps performed at the mobile phone whilst printing an email;

FIG. 8 is a flowchart showing steps performed at the MFP whilst printing an email;

FIG. 9 is a flowchart showing in more detail steps performed at the mobile phone when preparing to print an email according to a first embodiment of the present invention;

FIG. 10 is a flowchart showing in more detail steps performed at the MFP when preparing to print an email according to a first embodiment of the present invention;

FIG. 11 is a flowchart showing in more detail steps performed at the mobile phone when preparing to print an email according to a second embodiment of the present invention;

FIG. 12 is a flowchart showing in more detail steps performed at the MFP when preparing to print an email according to a second embodiment of the present invention

### DESCRIPTION OF THE EMBODIMENTS

### First Embodiment

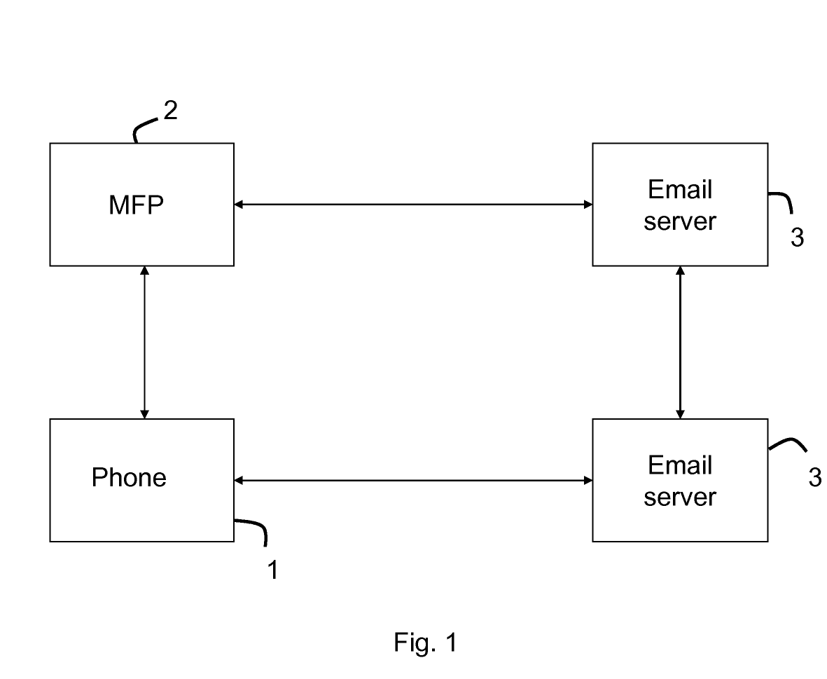

FIG. 1 shows architecture of a printing system of the first embodiment. The printing system comprises a mobile device in the form of a mobile phone 1, email servers 3, and a printing apparatus in the form of an MFP 2. Although a mobile phone 1 is described in the first embodiment, other embodiments could make use of a laptop computer, tablet computer, PDA or other mobile device. Further, although an MFP 2 is described in the first embodiment, other embodiments could make use of a single function printer or other printing apparatus.

The mobile phone 1, email servers 3, and MFP 2 are connected to each other. The nature of the connection is not important. However, for the purposes of the first embodiment, the MFP 2 and mobile phone 1 are connected to each other over Wi-Fi (IEEE 802.11). The mobile phone 1 and MFP 2 can each access the email servers 3 over an internet connection.

Not shown in FIG. 1 is that the mobile phone 1 is connected to a base station. The connection via the base station allows the mobile phone 1 to access the internet using a data connection such as UMTS, HSPA+, etc. The mobile phone 2 may connect to the email servers 3 via either the Wi-Fi connection or via the base station.

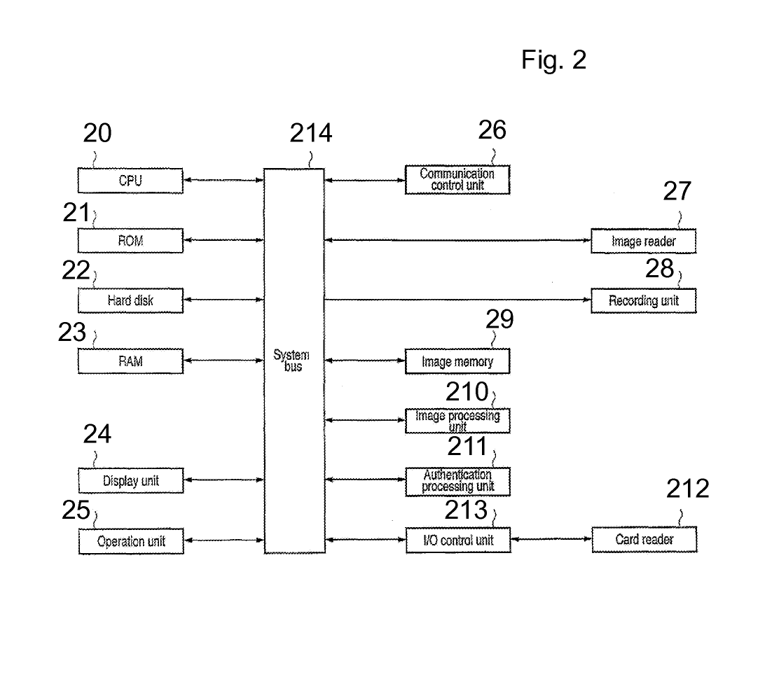

FIG. 2 shows hardware configuration of the MFP 2. The MFP 2 comprises a CPU 20, a ROM 21, a hard disk drive 22, and a RAM 23. These components are standard hardware components for computers and other devices and perform their usual functions. The MFP 10 further comprises a display unit 24, an operation unit 25, a communication control unit 26, an image reader 27, a recording unit 28, an image memory 29, an image processing unit 210, an authentication unit 211, a card reader 212, and an I/O control unit 213. The display unit 24 is a touch-screen LCD display provided on the MFP 2 to allow a user to make selections and view information on the MFP 2. The operation unit 25 is a keypad and other buttons to allow a user to enter settings and other information to the MFP 2. The communication control unit 26 is provided to allow the MFP 2 to communicate over Wi-Fi in order to access the mobile phone 1 and the email servers 3. The image reader 27 is a scanner that allows scanning of documents. The recording unit 28, shown in FIG. 2, represents parts of the MFP 2 dedicated to printing. The recording unit 28 functions to print image data onto a recording medium and output the recording medium for collection by a user. The image memory 29 is a memory provided for storage of image data during scanning by the image reader 27 or printing by the recording unit 28. The image-processing unit 210 represents various application specific integrated circuits (ASIC) provided in the MFP 2 in order to increase the speed of certain image processing operations, such as conversion of scanned R,G,B data into C,M,Y,K data during a copying operation. The authentication processing unit 211 is provided in order to authenticate user details received from the card reader 212. Data from the card reader 212 is received at the authentication unit 211 via an I/O control unit 213. The authentication unit may be implemented by software run using the CPU 20 and RAM 23 rather than as a separate hardware component. The components described above are interconnected via a system bus 214.

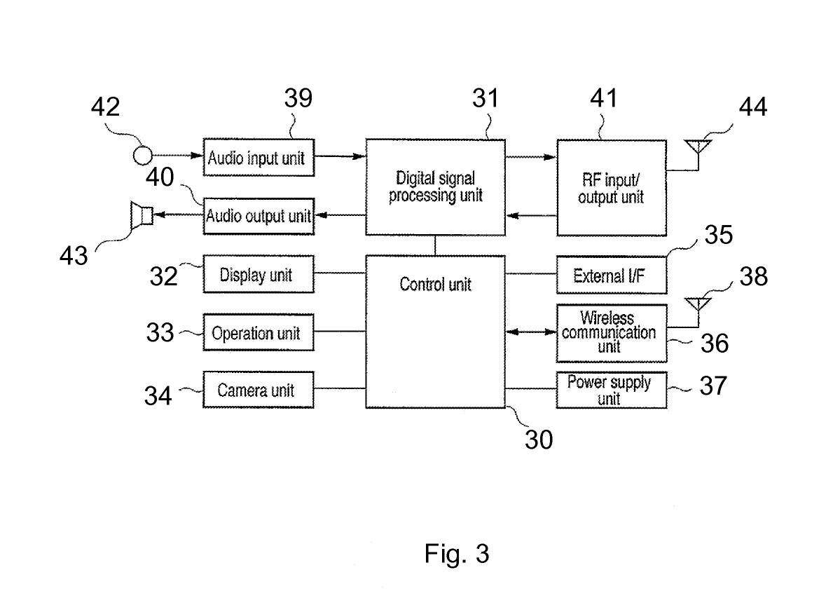

FIG. 3 shows the hardware configuration of the mobile phone 1. The mobile phone 1 comprises a control unit 30 connected to a digital signal processing unit 31. The control unit 30 controls operation of a display unit 32, an operation unit 33, a camera unit 34, an external I/F 35, a wireless communication unit 36, and a power supply unit 37. The display unit 32 comprises an LCD display for displaying information to a user of the mobile phone 1. The operation unit 33 comprises a keypad and other operation buttons to allow a user to make inputs into the mobile phone 1. The camera unit 34 is a camera that is integrated into the phone 1 to allow a user to take pictures and to collect visual information. The external I/F is a port provided in the mobile phone 1 to allow the mobile phone 1 to communicate with other devices. In particular the external I/F allows the mobile phone 1 to be connected to a computer for the purposes of synchronizing data (contact details, calendar entries etc.) stored on the mobile phone 1 with data stored on the computer. The wireless communication unit 36 provides support for various wireless services. In particular the wireless communication unit 36 provides support for Wi-Fi communication. The wireless communication unit 36 is connected to an antenna 38. The power supply unit 37 includes a battery and a mechanism for charging the battery from an external power supply.

The digital signal processing unit 31 is connected to an audio input unit 39, an audio output unit 40, and an RF input/output unit 41. The audio input unit 39 is an analogue to digital processor for receiving and converting audio signals from a microphone 42. The audio output unit 40 is a digital to analogue processor for receiving and converting digital signals into an analogue output to be output by a speaker 43. The RF input/output unit 41 is connected to an antenna 44 and is used to allow the mobile phone 1 to communicate with a local base station. The audio input unit 39, audio output unit 40, digital signal processing unit 31 and RF input/output unit 41 allow the mobile phone 1 to operate as a portable telephone.

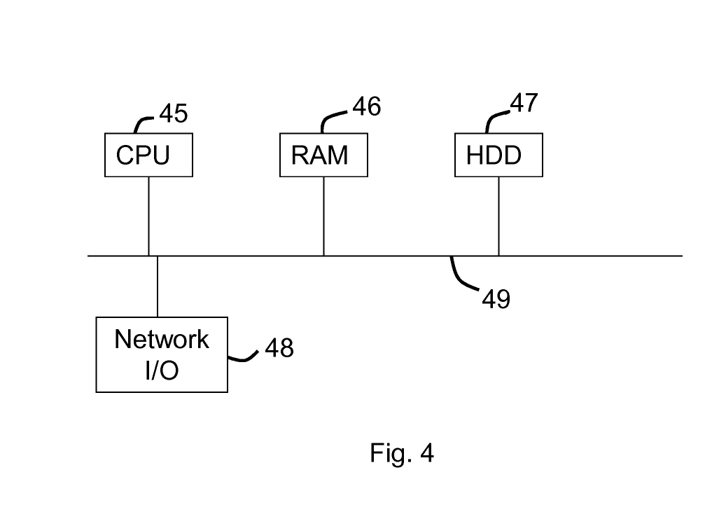

FIG. 4 is a schematic diagram of each of the email servers 3. The server 3 comprises a CPU 49, RAM 46, a hard disk drive 47, and a network I/O 48. The components are all connected by a Bus 49. The CPU 49, RAM 46, and hard disk drive 47 are standard items of computer hardware that perform their normal functions. The Network I/O connects the server 3 to the internet and allows access to the email server by the mobile phone 1 and the MFP 2.

Each email server 3 includes email software. An example of such software is Microsoft® exchange server. Alternatively, the email server 3 may be part of a cloud email service such as Gmail®, Hotmail® etc. The common feature of the email servers 3 is that they can receive, store, and supply emails using SMTP, IMAP, and/or POP3 protocols. It should be noted that the present invention is not limited by the particular email protocols used and that other protocols may be used according to circumstances/preferences.

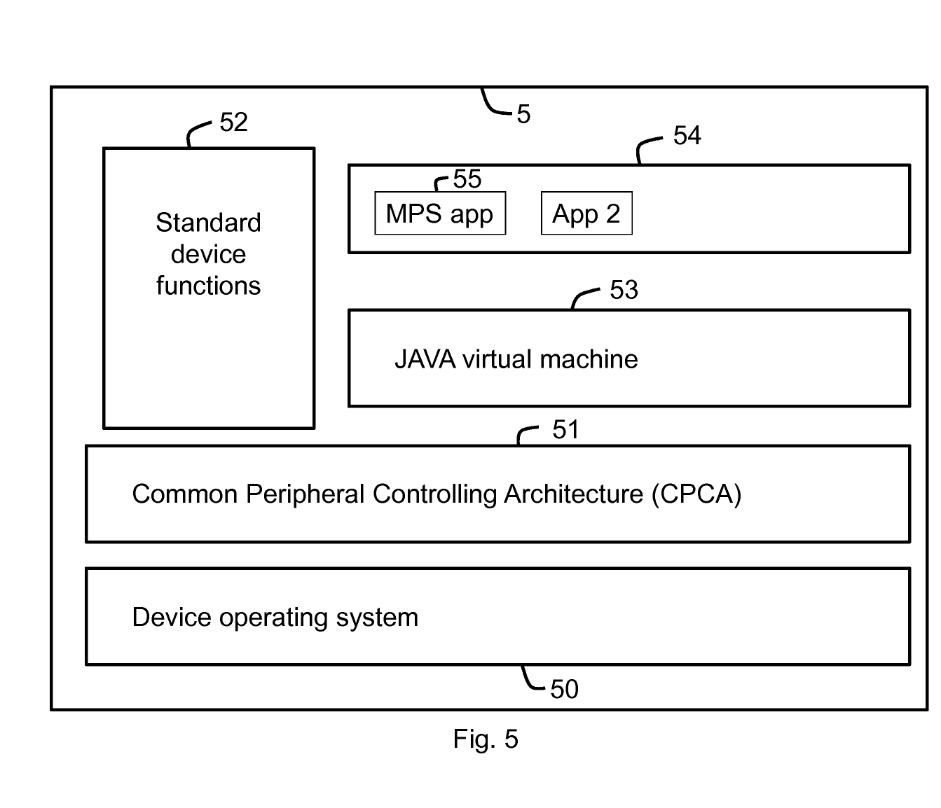

The MFP 2 includes the MEAP platform 5. The MEAP platform 5 is a suite of software provided on MFP devices sold by Canon®. The architecture of the MEAP platform 5 is illustrated in FIG. 5 and includes a device operating system 50. Above the operating system 50 is provided a Common Peripheral Device Architecture (CPCA) 51 which is a proprietary protocol and instruction set that is designed to support programming code for monitoring and reporting state errors in the MFP 2. Above that there is provided code 52 for standard device functions (printing, scanning, fax, etc.) and a JAVA virtual machine 53. Applications 54 (herein after ‘MEAP apps’) coded in JAVA may be installed on the MFP 2 and run by the JAVA virtual machine 53. A printer-side mobile print and scan app (MPS app) 55 is installed on the MFP 2 as shown in FIG. 5.

The mobile phone 1 is a so-called ‘smart phone’ and runs Google® Android® operating system 6. In other embodiments other types of phone can be used, including those running different mobile phone operating systems such as iOS from Apple®.

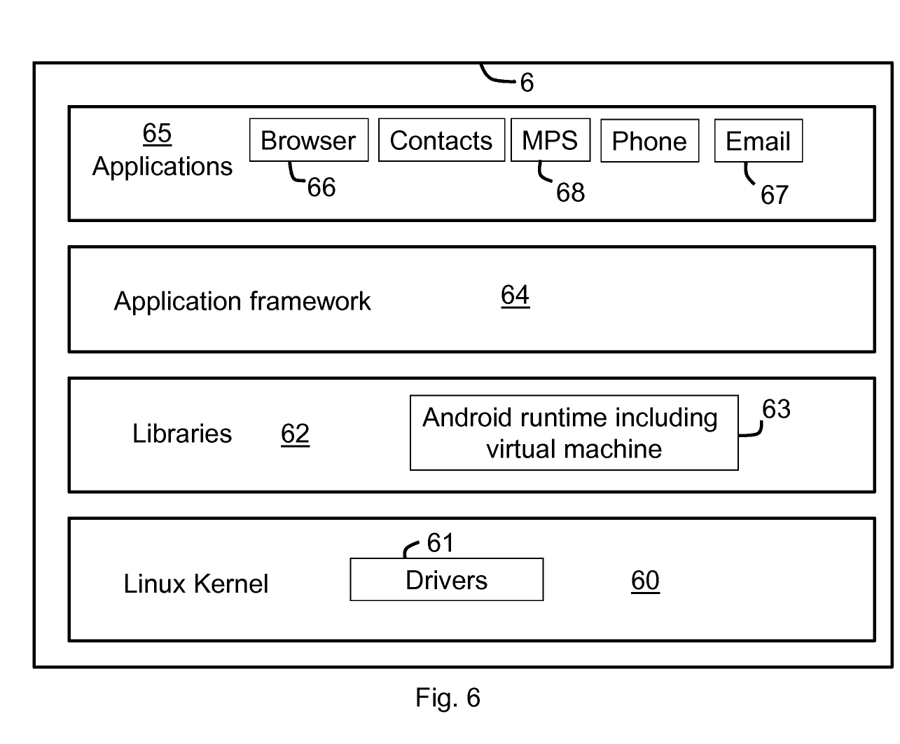

The Android® operating system 6 is schematically illustrated in FIG. 6. The Android® operating system 6 includes a Linux® kernel 60 and a number of device drivers 61. The device drivers 61 include drivers for the camera unit 34, display unit 32, operating unit 33 etc. Above that, there are provided a number of Libraries 62, including Libraries for Window management, 2D and 3D graphics, and a native browser engine. The Android operating system 6 also includes a Dalvik virtual machine 63 that allows applications written in the appropriate code to be run. Above the Libraries 62, an application framework 64 includes various tools and services for the mobile phone 1. The application framework 64 includes services such as an activity manager which manages processes running on the mobile phone 1. At the highest level, a number of applications 65 are installed on the mobile phone 1, including a browser application 66, an email application 67, a mobile print and scan (MPS) app 68 that is a counterpart app to the printer-side MPS app 55 installed on the MFP 2, and other applications such as a phone application, contacts application etc.

Before describing printing from the mobile phone 1 in more detail, a few comments about the configuration of the software applications are provided to aid understanding. The printer-side MPS app 55 is installed and configured by an administrator. Part of the configuration process is to set up an email account for the printer-side MPS app 55. Once the email account is configured, the printer-side MPS app 55 can send and receive emails via the email account. For the purposes of the present embodiment, it will be assumed that the printer-side MPS app 55 has been configured to receive emails at an address printer@randommail.com and that the email is set up using the IMAP protocol so that email messages that are received by the printer-side MPS app 55 are left on the email server 3 until they are explicitly deleted. Similarly, on the mobile phone the user has configured the Email app 67 to send and receive email. In this case, it is assumed that the email address configured is user@domesticmail.com. The user is taken to have been using the mobile phone 1 for a while such that the user has a number of email messages stored on the mobile phone 1, at least one of which the user would like to print.

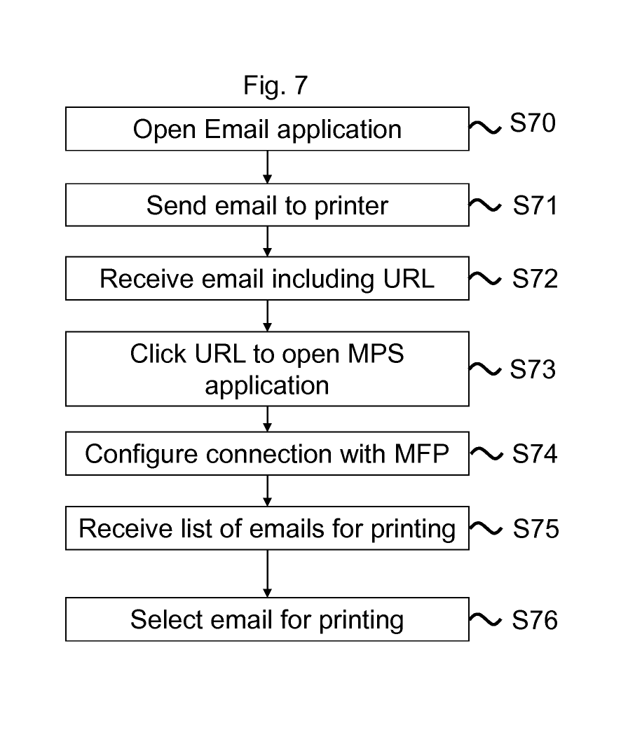

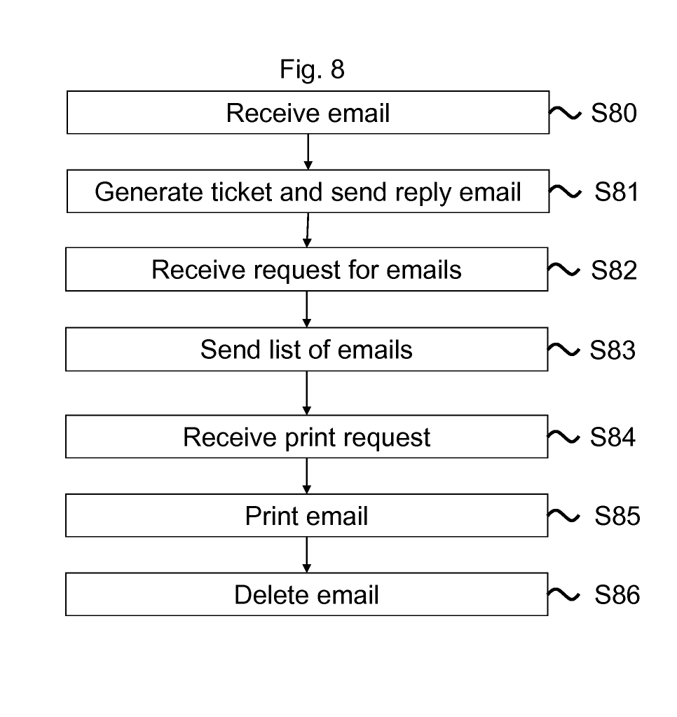

A description of printing from the mobile phone 1 will now be described with reference to FIGS. 7 and 8. FIG. 7 is a flowchart showing steps performed at the mobile phone 1 and FIG. 8 is a flowchart showing steps performed at the MFP 2. Firstly, in step S70, the user opens the Email app 67 and selects an email that he or she would like to print. The user then uses a forward function of the Email app 67 to send the selected email to the MFP 2, by entering the address printer@randommail.com in an address field of the email. In step S80, the printer-side MPS app 55 receives the email sent by the user.

In steps S81, the printer-side MPS app 55 generates an email reply to the received email, which email reply includes a custom URL that, when activated, will open the MPS app 68 on the mobile phone 1. For reasons that will be explained in more detail later, the custom URL includes encrypted data generated by encrypting the user's email address (user@domesticmail.com) and a time stamp created by the printer-side MPS app 55 just before the email reply is sent. The encrypted data is generated by first encrypting the email and time stamp using RSA encryption algorithm to generate a signature and then applying a symmetric encryption algorithm, such as DES (data encryption standard), to the signature. The custom URL takes the form mpas://[urldata], where urldata is the encrypted data. It should be noted that the encryption scheme described above is illustrative and that other encryption techniques could be used. The invention is not limited to the particular encryption algorithms or combination of encryption techniques applied.

The email reply including the custom URL is sent to the user's email address along with the encrypted data as an attachment. The encrypted data is added as an attachment to the reply email as some email apps do not support use of the custom URL. In such cases, the attached encrypted data may be opened by the MPS app 68 directly.

In step S72, the Email app 67 receives the email reply from the MFP 2. In step S73, when the user wants to print the sent email, the user opens the received email reply and clicks on the custom URL. Activation of the custom URL opens the MPS app 68 on the mobile phone 1 and passes the value of the encrypted data created by the printer-side MPS app 55 to the MPS app 68 on the mobile phone 1.

In step S74, upon opening the MPS app 68 on the mobile phone 1, the MPS app 68 prompts the user to configure a connection with the MFP 2. There are several known methods for configuring such a HTTP connection, such as requiring the user to manually enter configuration details including an IP address of the MFP 2 into the MPS app 68. Another method is to display a machine readable code, such as a QR code, on the display of the MFP 2 when the printer-side MPS app 55 is launched on the MFP 2. The displayed QR code includes the necessary address information (IP address) for the MFP 2. The MPS app 68 on the mobile phone 1 reads the displayed QR code using the camera unit 34 on the mobile phone 1 so that the Wi-Fi connection can be configured. Whichever method is used, a HTTP connection is established between the mobile phone 1 and the MFP 2 in step S74.

Next the MPS app 68 on the mobile phone 1 requests a list of emails available for printing at the MFP 1. The request includes the encrypted data generated by the printer-side MPS app 55 generated in step S81. In step S82, the printer-side MPS app 55 at the MFP 2 receives the request and decrypts the encrypted data to obtain the sender email address and time stamp. Having identified the relevant email address, the printer-side MPS app 55 of the MFP 2 searches the email account printer@randommail.com for all emails from the same sender (user@domesticmail.com) and, in step S83, sends the list of emails to the mobile phone 1.

At this stage, the purpose of generating encrypted data using the sender's email address (user@domesticmail.com in this example) and the time stamp can be appreciated. A potential problem with this type of system how to provide security for emails sent for printing. By generating the encrypted data and including it in the custom URL sent back to the mobile phone 1, only a user that has access to the email reply from the printer-side MPS app 55 can print the emails from that email address.

The MPS app 68 at the mobile phone 1 receives and displays the list of emails S75 on the mobile phone 1. The user then selects an email for printing in step S76 and a request to print the email, including information that identifies the selected email, is sent from the MPS app 68 on the mobile phone 1 to the printer-side MPS app 55 on the MFP 2.

In step S84, the printer-side MPS app 55 at the MFP 1 receives the print request and, in step S85, the email is printed. In order to print the email, the printer-side MPS app 55 retrieves the email identified in the print request from the email server 3 and passes the email to a standard device function 52 of the MFP 2 for printing.

In step S86, once the email has been printed, the email may be deleted from the email server 3 by the printer-side MPS app 55. This process may be performed periodically by deleting emails that have been stored for a predetermined period of time and are deemed to have expired.

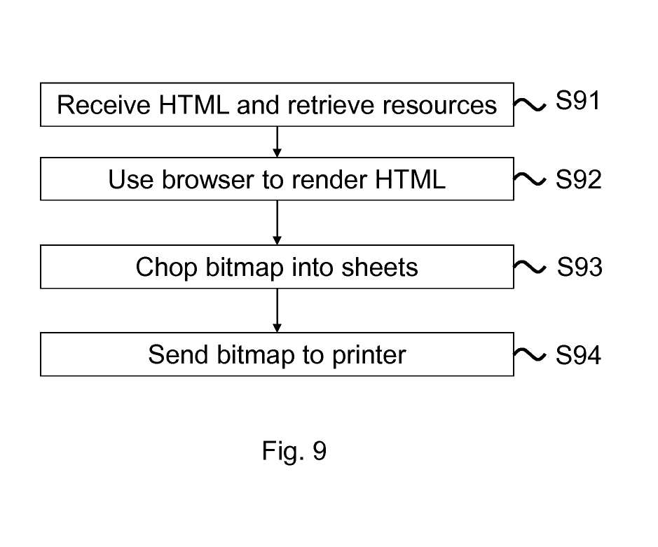

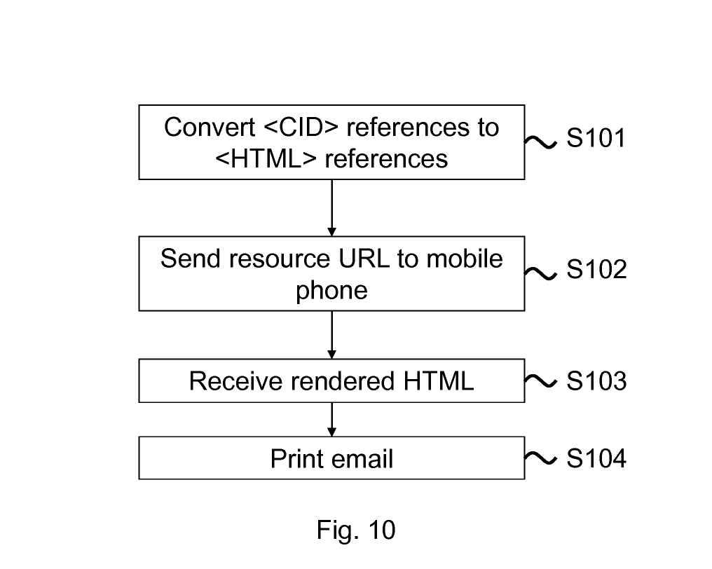

The above description of step S85 works well for emails in plain text format, or any other format which can be dealt with natively by the standard device functions 52 of the MFP 2. However, problems arise when the email is formatted in HTML, which in this embodiment is not supported by the MFP 2. FIGS. 9 and 10 illustrate a method of printing HTML emails in this circumstance. The method allows rendering of the HTML emails by use of a browser function on the mobile phone 1.

Having received the print request in step S85, the printer-side MPS app 55 retrieves the identified email in HTML format from the email server 3. In addition to the language format, a problem with HTML emails is that they tend to refer to image files using commands in the following format:

<img src=“cid:imagename.png”>

However, this format is used not commonly used outside of email messages and needs to be replaced if the HTML is to be rendered by the browser function on the mobile phone 1. Accordingly, in step S101, the printer-side MPS app 55 generates a resource file on the MFP 1, including images and HTML, by replacing the embedded image references in the HTML with references in the following format:

<img src=“http:imagename.png”>

In other words, ‘cid’ references are replaced with ‘http’ references.

In step S102, the printer-side MPS app 55 sends a URL to the mobile phone 1 that identifies the resource generated in step S101. In step S91 the MPS app 68 on the mobile phone 1 receives the URL, retrieves the resource from the MFP 2, and passes the resource file to a browser function within the application framework 64 of the mobile phone 1. In step S92, the browser function renders the HTML into a bitmap format. In step S93, the MPS app 68 receives the bitmap image from the browser function and performs a chopping operation S93. The chopping operation is necessary because the rendered bitmap is not separated into pages for printing. Having divided the bitmap image into separate bitmap images corresponding to each page that should be printed by the MFP 2, the MPS app 68 sends the bitmap image files to the printer-side MPS app 55.

In step S103, the printer-side MPS app 55 receives the bitmap image files from the mobile phone 1 and in step S104, the printer-side MPS app 55 passes the bitmap image files to the standard device functions 52 for printing.

The above-described embodiment has the following advantages. Firstly, the steps of sending the email to the MFP 2 from the mobile phone 1 and then accessing a list of sent emails from the MFP 2 allows printing of emails from the mobile phone 1 in a case where it is not possible to access the emails in the Email app 67 directly from the MPS app 68.

Secondly, by encrypting the user's email address and the time stamp, it is possible to preserve security of the user's emails making the process resistant to unauthorized attempts to print other user's emails.

Thirdly, a problem that HTML emails cannot be natively rendered at the MFP 2 may be overcome by replacing references within the HTML emails and rendering the emails using a browser function at the mobile phone 1. In this way, HTML emails with embedded images may be properly printed.

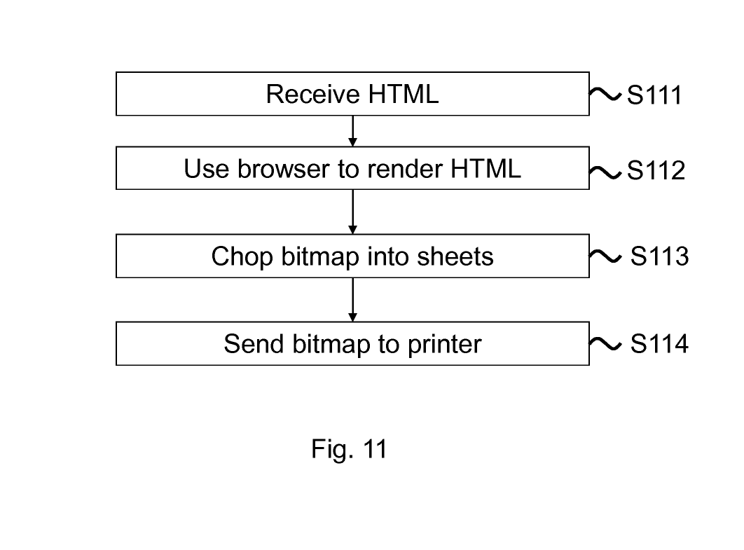

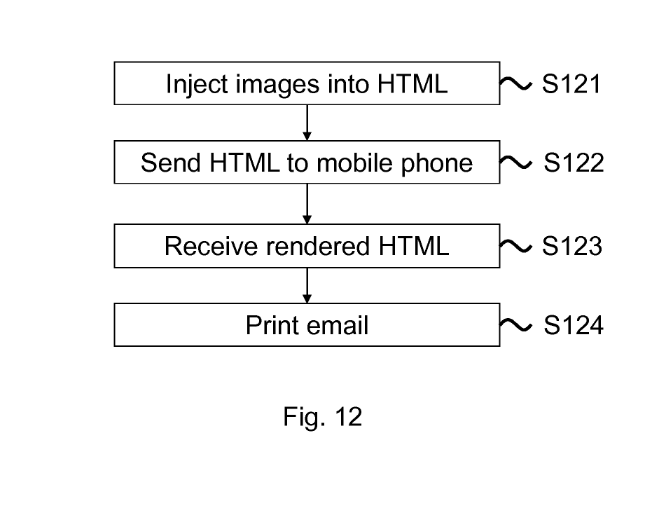

A second embodiment of the present invention will now be described with reference to FIGS. 11 and 12. The second embodiment provides a second way of printing HTML emails. The second embodiment is identical to the first embodiment except in the details of step S85, which will be described in detail below.

Having received the print request in step S85, the printer-side MPS app 55 at the MFP 2 retrieves the identified email in HTML format from the email server 3. As mentioned above, in addition to the language format, a problem with HTML emails is that they tend to refer to image files using commands in the following format:

<img src=“cid:imagename.png”>

In the second embodiment, the MPS app 68 at the MFP 2 identifies references of the type above and injects, S121, the referenced images into the HTML in base64 format. The updated HTML is then sent, S122, to the mobile phone 1. In step S111 the MPS app 68 on the mobile phone 1 receives the updated HTML from the MFP 2 and passes the HTML to the browser function. In step S112, the browser function renders the HTML into a bitmap format. In step S113, the MPS app 68 receives the bitmap image from the browser function and performs a chopping operation. The chopping operation is necessary because the rendered bitmap is not separated into pages for printing. Having divided the bitmap image into separate bitmap images corresponding to each page that should be printed by the MFP 2, the MPS app 68 sends the bitmap image files to the printer-side MPS app 55 in step S114.

In step S123, the printer-side MPS app 55 on the MFP 2 receives the bitmap image files from the mobile phone 1 and in step S124, the printer-side MPS app 55 passes the bitmap image files to the standard device functions 52 for printing.

Embodiments of the present invention have been described above. Further embodiments of the present invention can also be realized by systems that read out and execute programs recorded on a memory device to perform the functions of the above-described embodiment(s), and by a method, the steps of which are performed by, for example, reading out and executing a program recorded on a memory device to perform the functions of the above-described embodiment(s). For this purpose, the program may be provided to the printing system, for example via a network or from a recording medium of various types serving as the memory device (e.g., computer-readable medium).

1. A printing system comprising a mobile device and a printing apparatus, the mobile device comprising:
a printing application and an email application, wherein the email application is operable to forward an email for printing to an email address associated with a printing apparatus, and the printing application is operable to send an instruction to print an email to the printing apparatus;
and the printing apparatus comprising a printer-side application operable, in response to the instruction, to retrieve an email for printing from the email address associated with the printing apparatus and to cause printing of the retrieved email.

2. A printing system according to claim 1, wherein the email application is operable to receive identifying information in response to the sent email, and to pass the identifying information from the email application to the printing application on the mobile device.

3. A printing system according to claim 2, wherein the printing application is operable to send a request to the printer-side application including the identifying information and to receive and display a list of emails that may be printed, and the printer-side application is configured to receive the request including the identifying information and to search for emails received at the email address associated with the printing apparatus in order to generate a list of emails that may be printed, and to send the list of emails that may be printed to the printing application at the mobile device.

4. A printing system according to claim 3, wherein the printing application is configured to send to the printing apparatus an instruction to print an email selected by a user from the list of emails.

5. A printing system according to claim 3, wherein the printer-side application is configured to identify an email address associated with the identifying information and to form a list of emails that have been sent from the email address.

6. A printing system according to claim 1, wherein the printer-side application is configured to generate the identifying information that identifies a received email upon receipt of the email for printing from the email application.

7. A printing system according to claim 6, wherein the identifying information is unique identifying information generated based on details of the received email for printing.

8. A printing system according to claim 7, wherein the identifying information is generated using the sender's email address and a time stamp.

9. A printing system according to claim 1 wherein, the printer-side application is further configured to, in a case where the retrieved email is in an unsupported format, cause the email content to be rendered at the mobile device prior to printing by the printing apparatus.

10. A printing system according to claim 9, wherein the printer-side application is configured to generate a resource by replacing references in email code of the retrieved email and wherein the printing application on the mobile device is configured to obtain the resource and cause the resource to be rendered.

11. A printing system according to claim 10, wherein the printing application is configured to cause the resource to be rendered by passing the resource to browser software on the mobile device.

12. A printing system according to claim 9, wherein the printer-side application is configured to generate a resource by injecting images referred to in the email code of the retrieved email into the email code and wherein the printing application on the mobile device is configured to cause the resource to be rendered.

13. A mobile device comprising a printing application and an email application, wherein the email application is operable to forward an email for printing to an email address associated with a printing apparatus, to receive identifying information at the email application in response to the sent email, and to pass the identifying information from the email application to the printing application, and the printing application is operable to send an instruction to print an email to the printing apparatus.

14. A printing apparatus comprising a printer-side application configured to generate the identifying information that identifies a received email upon receipt of an email for printing sent to an email address associated with the printing apparatus from an email application of a mobile device, and operable to retrieve an email for printing from the email address associated with the printing apparatus and to cause printing of the retrieved email upon receipt of an instruction to print the email.

15. A method of printing an email comprising the steps of:
sending an email to be printed to an email address associated with a printing apparatus using an email application on a mobile device;
using a printing application to send an instruction to print an email to the printing apparatus; and
the printing apparatus, in response to the instruction, retrieving the email for printing from the email address associated with the printing apparatus and printing the retrieved email.

16. A non-transitory computer-readable storage medium storing a printer-side application configured to generate identifying information that identifies a received email upon receipt of an email for printing sent to an email address associated with the printing apparatus from an email application of a mobile device, and operable to retrieve an email for printing from the email address associated with the printing apparatus and to cause printing of the retrieved email upon receipt of an instruction to print the email.

17. A non-transitory computer-readable storage medium storing a printing application operable to receive identifying information from an email application; to send a request to a printer-side application on an printing apparatus, including the identifying information, to receive a list of emails that may be printed from the printer-side application; to display the list of emails that may be printed; and to send an instruction to print an email to the printing apparatus.
